(19) United States
(12) Patent Application Publication
(10) Pub. No.: US 2026/0187689 A1
(43) Pub. Date: Jul. 2, 2026

(54) LIVE-STREAMING INFORMATION DISPLAY METHOD AND APPARATUS, AND COMPUTER STORAGE MEDIUM

(71) Applicant: BEIJING BYTEDANCE NETWORK TECHNOLOGY CO., LTD., Beijing (CN)

(72) Inventor: Enhua Zhang, Beijing (CN)

(21) Appl. No.: 18/728,380

(22) PCT Filed: Feb. 1, 2023
(86) PCT No.: PCT/CN2023/074118

§ 371 Date: Jul. 11, 2024

(30) Foreign Application Priority Data
Mar. 15, 2022 (CN) 202210254188.7

(51) Int. Cl. G06Q 30/0601; H04N 21/2187; H04N 21/431; H04N 21/478

(52) U.S. Cl. CPC G06Q 30/0625; H04N 21/2187; H04N 21/4316; H04N 21/47815; G06Q 30/0643

(57) ABSTRACT

The present disclosure provides a livestreaming information display method and apparatus, and a computer device and a storage medium. The method includes: receiving a search request from a client, and determining a livestreaming room matched with the search request; in response to there are a plurality of products in the livestreaming room, determining, from the plurality of products in the livestreaming room, a target product that is configured to be displayed in a livestreaming card, wherein the products include a first product listed in the livestreaming room in a current livestreaming, and a second product listed in the livestreaming room in various livestreaming within preset time; and sending livestreaming preview information corresponding to the livestreaming room and product information of the target product to the client to cause the client displays, on a search result page.

### CROSS-REFERENCE TO RELATED APPLICATION(S)

This application claims priority to Chinese Patent Application No. 202210254188.7, entitled “LIVE-STREAMING INFORMATION DISPLAY METHOD AND APPARATUS, AND COMPUTER STORAGE MEDIUM”, filed with the China National Intellectual Property Administration on Mar. 15, 2022, which is incorporated by reference in its entirety.

### FIELD

The present disclosure relates to the technical field of Internet, and in particular, to a livestreaming information display method and apparatus, and a computer storage medium.

### BACKGROUND

When a user initiates a search, if there is a livestreaming room that is matched with search information of the user, a livestreaming card corresponding to the livestreaming room would be displayed in a search result.

If the user mainly intends to quickly find a relevant product when initiating the search, it is usually difficult to provide the user with an effective reference suggestion in a case that there are many products, displayed in the livestreaming card, in the livestreaming room. The user needs to trigger every product to enter a corresponding product detail page for viewing and confirmation, causing low efficiency of obtaining a desired result.

### SUMMARY

Embodiments of the present disclosure at least provide a method and apparatus, and a computer storage medium for livestreaming information display.

In a first aspect, the embodiments of the present disclosure provide a method for displaying livestreaming information, including:
receiving a search request from a client to determine a livestreaming room matched with the search request;
in a case that there are a plurality of products in the livestreaming room, determining, from the plurality of products in the livestreaming room, a target product that is configured to be displayed in a livestreaming card, wherein the products include a first product listed in the livestreaming room in a current livestreaming, and a second product listed in the livestreaming room in various livestreaming within preset time; and
sending livestreaming preview information corresponding to the livestreaming room and product information of the target product to the client to cause the client displays, on a search result page, a livestreaming card containing the livestreaming preview information and the product information of the target product.

In an alternative implementation, there are a plurality of target products; the plurality of target products are products matched with the search request; or, partial products among the plurality of target products are matched with the search request, and the remaining products are products that are combined with the partial products.

In an alternative implementation, a determining process of the product information of the target products that are displayed on the search result page includes:
determining distinguishing information of the plurality of target products for at least one attribute type; and
using the distinguishing information under the at least one attribute type as the product information that is displayed on the search result page.

In an alternative implementation, the determining, from the plurality of products in the livestreaming room, a target product that is configured to be displayed in a livestreaming card includes:
selecting, from a plurality of first products listed in the livestreaming room in the current livestreaming, a product as the target product, wherein a relevance between the product and the search request satisfies a first preset condition; and
selecting, from a plurality of second products listed in the livestreaming room in the various livestreaming within the preset time, a product as the target product, wherein a relevance between the product and the search request satisfies a second preset condition.

In a second aspect, the embodiments of the present disclosure provide another method for displaying livestreaming information, including:
in response to a search request from a user, obtaining livestreaming preview information of a livestreaming room matched with the search request and product information of a target product, wherein the target product is selected from a plurality of products in the livestreaming room, and the product includes a first product listed in the livestreaming room in a current livestreaming, and a second product listed in the livestreaming room in various livestreaming within preset time; and
displaying, on a search result page, a livestreaming card corresponding to the livestreaming room, displaying the livestreaming preview information in a first region in the livestreaming card, and displaying the product information of the target product in a second region of the livestreaming card.

In an alternative implementation, there are a plurality of target products; the plurality of target products are products matched with the search request; or, partial products among the plurality of target products are matched with the search request, and the remaining products are products that are combined with the partial products.

In an alternative implementation, the product information of the target product displayed on the search result page includes: distinguishing information of the plurality of target products for at least one attribute type.

In an alternative implementation, the target product is a product that is being livestreamed in the livestreaming room; and
after the displaying, on the search result page, the livestreaming card corresponding to the livestreaming room, the method further includes:
in response to a triggering operation performed on the livestreaming preview information or the product information of the target product, playing livestreaming content of the livestreaming room in full screen from a current introduction position where the target product is introduced.

In an alternative implementation, the target product is a product that has been livestreamed in the livestreaming room; and
after the displaying, on the search result page, the livestreaming card corresponding to the livestreaming room, the method further includes:
in response to a triggering operation performed on the livestreaming preview information, playing livestreaming content of the livestreaming room in full screen from a start introduction position or a current introduction position of the livestreaming room; or,
in response to a triggering operation performed on the product information of the target product, playing livestreaming content of the livestreaming room in full screen from a historical introduction position where the target product is introduced.

In a third aspect, the embodiments of the present disclosure further provide an apparatus for displaying livestreaming information, including:
a first determining module, configured to receive a search request from a client to determine a livestreaming room matched with the search request;
a second determining module, configured to in a case that there is a plurality of products in the livestreaming room, determine, from the plurality of products in the livestreaming room, a target product that is configured to be displayed in a livestreaming card, wherein the products include a first product listed in the livestreaming room in a current livestreaming, and a second product listed in the livestreaming room in various livestreaming within preset time; and
a sending module, configured to send livestreaming preview information corresponding to the livestreaming room and product information of the target product to the client, so that the client displays, on a search result page, a livestreaming card containing the livestreaming preview information and the product information of the target product.

In an alternative implementation, there are a plurality of target products; the plurality of target products are products matched with the search request; or, partial products among the plurality of target products are matched with the search request, and the remaining products are products that are combined with the partial products.

In an alternative implementation, the second determining module is configured to determine the product information of the target products that are displayed on the search result page according to the following steps:
determining distinguishing information of the plurality of target products for at least one attribute type; and
using the distinguishing information under the at least one attribute type as the product information that is displayed on the search result page.

In an alternative implementation, the second determining module is configured to select, from a plurality of first products listed in the livestreaming room in the current livestreaming, a product as the target product, wherein a relevance between the product and the search request satisfies a first preset condition; and
select, from a plurality of second products listed in the livestreaming room in the various livestreaming within the preset time, a product as the target product, wherein a relevance between the product and the search request satisfies a second preset condition.

In a fourth aspect, the embodiments of the present disclosure further provide an apparatus livestreaming information display, including:
an obtaining module, configured to: in response to a search request from a user, obtain livestreaming preview information of a livestreaming room matched with the search request and product information of a target product, wherein the target product is selected from a plurality of products in the livestreaming room, and the product includes a first product listed in the livestreaming room in a current livestreaming, and a second product listed in the livestreaming room in various livestreamings within preset time; and
a display module, configured to: display, on a search result page, a livestreaming card corresponding to the livestreaming room, display the livestreaming preview information in a first region in the livestreaming card, and display the product information of the target product in a second region of the livestreaming card.

In an alternative implementation, there are a plurality of target products; the plurality of target products are products matched with the search request; or, partial products among the plurality of target products are matched with the search request, and the remaining products are products that are combined with the partial products.

In an alternative implementation, the product information of the target product displayed on the search result page includes: distinguishing information of the plurality of target products for at least one attribute type.

In an alternative implementation, the target product is a product that is being livestreamed in the livestreaming room; and
the apparatus further includes a playing module, configured to: after displaying, on the search result page, the livestreaming card corresponding to the livestreaming room, in response to a triggering operation performed on the livestreaming preview information or the product information of the target product, play livestreaming content of the livestreaming room in full screen from a current introduction position where the target product is introduced.

In an alternative implementation, the target product is a product that has been livestreamed in the livestreaming room; and
the apparatus further includes a playing module, configured to: after displaying, on the search result page, the livestreaming card corresponding to the livestreaming room, in response to a triggering operation performed on the livestreaming preview information, play livestreaming content of the livestreaming room in full screen from a start introduction position or a current introduction position of the livestreaming room; or,
in response to a triggering operation performed on the product information of the target product, play livestreaming content of the livestreaming room in full screen from a historical introduction position where the target product is introduced.

In a fifth aspect, the embodiments of the present disclosure further provide a computer device, including: a processor, a memory, and a bus, wherein the memory stores machine-readable instructions executable by the processor; when the computer device is run, the processor communicates with the memory through the bus; and the machine-readable instructions, when executed by the processor, execute the steps of the livestreaming information display method in the first aspect or any possible implementation in the first aspect.

In a sixth aspect, the embodiments of the present disclosure further provide a computer-readable storage medium, having a computer program stored thereon. The computer program, when run by a processor, executes the steps of the livestreaming information display method in the first aspect or any possible implementation in the first aspect.

Effects of the above livestreaming information display apparatus, the computer device, and the computer-readable storage medium are described with reference to the explanation of the above livestreaming information display method, and will not be elaborated here.

According to the livestreaming information display method and apparatus, and the computer device and the storage medium provided by the embodiments of the present disclosure, a search request from a client is received, and a livestreaming room matched with the search request is determined; in a case that there are a plurality of products in the livestreaming room, a target product that is configured to be displayed in a livestreaming card is determined from the plurality of products in the livestreaming room, wherein the products include a first product listed in the livestreaming room in a current livestreaming, and a second product listed in the livestreaming room in various livestreaming within preset time; and livestreaming preview information corresponding to the livestreaming room and product information of the target product are sent to the client, so that the client displays, on a search result page, a livestreaming card containing the livestreaming preview information and the product information of the target product.

To be specific, according to the embodiments of the present disclosure, in a case that a searched livestreaming room contains a plurality of products, a target product displayed in a livestreaming card is selected from the plurality of products in the livestreaming room. Filtering and limited displaying of the products can provide a user with an effective reference suggestion, so that the user can better and more quickly obtain a desired effect.

In order to make the above objectives, features, and advantages of the present disclosure more apparent and understandable, the following text provides preferred embodiments. A detailed explanation is made below in conjunction with the accompanying drawings.

### BRIEF DESCRIPTION OF THE DRAWINGS

In order to explain the technical solutions of the embodiments of the present disclosure more clearly, the drawings required to be used in the embodiments are briefly introduced below. The drawings here are incorporated into and form part of this specification. These drawings show the embodiments that comply with the present disclosure, and are used together with this specification to explain the technical solutions of the present disclosure. It should be understood that the accompanying drawings below only show some embodiments of the present disclosure. Therefore, the embodiments shall not be regarded as limitations on the scope. A person of ordinary skill in the art can also derive other relevant drawings according to these drawings without creative work.

FIG. 1 is a flowchart of a livestreaming information display method provided by an embodiment of the present disclosure;

FIG. 2 is a flowchart of another livestreaming information display method provided by an embodiment of the present disclosure;

FIG. 3a is a schematic diagram of displaying a target product on a search result page provided by an embodiment of the present disclosure;

FIG. 3b is a schematic diagram of displaying a plurality of target products on a search result page provided by an embodiment of the present disclosure;

FIG. 4 is a schematic diagram of a livestreaming information display apparatus provided by an embodiment of the present disclosure;

FIG. 5 is a schematic diagram of another livestreaming information display apparatus provided by an embodiment of the present disclosure; and

FIG. 6 is a schematic structural diagram of a computer device provided by an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure are clearly described below with reference to the accompanying drawings in the embodiments of the present disclosure. Apparently, the described embodiments are merely some rather than all of the embodiments of the present disclosure. Assemblies of the embodiments of the present disclosure commonly described and shown here may be arranged and designed in a variety of different configurations. Therefore, the following detailed descriptions of the embodiments of the present disclosure below are not intended to limit the scope of the claimed present disclosure, but merely represents selected embodiments of the present disclosure. All other embodiments obtained by a person skilled in the art based on the embodiments of the present disclosure without making creative efforts shall fall within the protection scope of the present disclosure.

In addition, the terms “first”, “second”, and the like in this specification and the claims, as well as the above accompanying drawings in the embodiments of the present disclosure are defined to distinguish similar objects, and do not have to be used to describe a specific order or sequence. It should be understood that such used data is interchangeable where appropriate, so that the embodiments described here can be implemented in an order other than content shown or described here.

The term “plurality or several” mentioned herein means tone or more. The term “and/or” describes an association relationship of associated objects, representing that three relationships may exist. For example, A and/or B may represent three situations: A exists alone; A and B exist simultaneously; and B exists alone. The character “/” usually indicates an “or” relation between associated objects.

It is found via research that when a user initiates a search, if there is a livestreaming room that is matched with search information of the user, a livestreaming card corresponding to the livestreaming room would be displayed in search results.

If a main demand of the user when initiating the search is to quickly find a relevant product, it is usually difficult to provide the user with an effective reference suggestion in a case that there are many products in the livestreaming room, which are displayed in the livestreaming card. The user needs to trigger every product to enter a corresponding product detail page for viewing and confirmation, causing low efficiency of obtaining a desired result.

Based on the above problem that a user cannot obtain an effective reference suggestion in a timely manner if there are a plurality of products in a livestreaming room, the present disclosure provides a livestreaming information display method. In a case that a searched livestreaming room contains a plurality of products, a target product displayed in a livestreaming card is selected from the plurality of products in the livestreaming room. Filtering and limited displaying of the products can provide a user with an effective reference suggestion, so that the user can better and more quickly obtain a desired effect.

It should be noted that similar reference numerals and letters indicate similar items in the following drawings. Therefore, once a certain item is defined in one drawing, it is unnecessary to further define and explain it in the subsequent drawings.

For ease of understanding this embodiment, a method for display livestreaming information disclosed by an embodiment of the present disclosure is introduced in detail first. An executive body of the livestreaming information display method provided by an embodiment of the present disclosure is generally a computer device with a computing ability. The computer device includes, for example, a terminal device or server or another processing device. In some possible implementations, the livestreaming information display method may be achieved by a processor by calling computer-readable instructions stored in a memory.

The embodiments of the present disclosure provide a livestreaming information display method applied to a server side. A server serving as an executive body is taken as an example to explain the livestreaming information display method provided by an embodiment of the present disclosure.

FIG. 1 is a flowchart of a method for displaying livestreaming information provided by an embodiment of the present disclosure. The method for displaying livestreaming information provided by an embodiment of the present disclosure may be applied to a comprehensive search scenario and mainly include S101 to S103 below:

S101: A search request from a client is received, and a livestreaming room matched with the search request is determined.

In this step, the search request may carry search information input by a user, such as a search term, a query statement, or a query voice that is input at a query entry of the client. The client may include but is not limited to: a webpage side of a target webpage, an application client, and the like.

In an implementation, the livestreaming room matched with the search request may be determined based on semantic matching results between livestreaming content of various pre-stored livestreaming rooms and search information.

Exemplarily, the livestreaming content in the livestreaming room may include a title, comments, product description information, video image information, and the like. Semantic relevance between the title, comments, product description information and video image information and the search information may be respectively determined through a semantic recognition algorithm. An average or maximum relevance is used as a semantic matching result to determine the livestreaming room matched with the search request.

S102: In a case that there is a plurality of products in the livestreaming room, a target product that is configured to be displayed in a livestreaming card is selected from the plurality of products in the livestreaming room, wherein the products include a first product listed in the livestreaming room in a current livestreaming, and a second product listed in the livestreaming room in various livestreaming within preset time.

In a case that there is a plurality of products in the livestreaming room, one or more target products that meet the search request may be selected from the plurality of products in the livestreaming room.

The current livestreaming means a livestreaming that is currently being livestreamed. The various livestreaming within the preset time mean different livestreaming in a historical period of time, namely, different livestreaming that have already been livestreamed. Products listed in each livestreaming are products introduced in the livestreaming process. A plurality of products may be listed in each livestreaming room, and each product corresponds to its own livestreaming content (i.e., the title, the product description information, and the video image information).

In some embodiments, in a case that one target product is selected, the target product may be a first product matched with the search request or a second product matched with the search request. In specific implementation, a first product, a relevance of which to the search request satisfies a condition (for example, the relevance is the largest and is greater than a threshold), may be preferentially selected as the target product from a plurality of first products listed in the livestreaming room in the current livestreaming. In a case that there is no first product satisfying the condition, a second product, a relevance of which to the search request satisfies a condition (for example, the relevance is the largest and is greater than a threshold), may be then selected as the target product from second products listed in the livestreaming room in the various livestreaming within the preset time.

The relevance here may be determined based on a semantic relevance between product-related information (such as the product description information) and the search information in the search request, and any information that affects a matching degree between the product and the search request, such as a combination degree introduced below.

In some other embodiments, in a case that there is a plurality of target products, the plurality of target products are displayed in the livestreaming card. The plurality of target products displayed in the livestreaming card may be products matched with the search request. Or, partial products among the plurality of target products are matched with the search request, and the remaining products are products that are combined with the partial products.

In an implementation, the plurality of target products may all be products matched with the search request. In a specific implementation, the plurality of target products may be first products matched with the search request or second products matched with the search request. Exemplarily, first products matched with the search request may be preferentially selected as the target products from a plurality of first products listed in the livestreaming room in the current livestreaming. In a case that the quantity of the selected first products does not exceed an upper limit of the quantity of the target products, second products matched with the search request may be then additionally selected as the target products from a plurality of second products listed in the livestreaming room in the various livestreaming within the preset time.

In another implementation, partial products among the plurality of target products may be matched with the search request, and the remaining products are products that are combined with the above partial products. The products that are combined with the partial products may be products that meet a combination condition with the partial products, such as products that make up shampoo sets, products that make up clothing sets, or products that make up a discount activity with the partial products.

Exemplarily, if the partial products are down jackets, the products that are combined with the partial products, namely, the remaining products, may include warm underwear, windbreaker jackets, and the like. For another example, if the partial products are lipsticks, the products that are combined with the partial products, namely, the remaining products, may include eyeshadow compacts, cosmetic cases, and the like.

In an implementation, the plurality of target products displayed in the livestreaming card may be selected from the plurality of first products and the plurality of second products mentioned above. Specifically, products, relevance of which to the search request satisfy a first preset condition, may be selected as the target products from the plurality of first products listed in the livestreaming room in the current livestreaming, and products, relevance of which to the search request satisfy a second preset condition, may be selected as the target products from the second products listed in the livestreaming room in the various livestreaming within the preset time.

Exemplarily, if the relevance between relevant information of a product (i.e., the first product or second product) and the search information corresponding to the search request is greater than or equal to a preset relevance threshold, the product may be used as a target product; or, the relevance between a plurality of products and the search request are sorted in an order from large to small, and products corresponding to a preset number of relevance ranked in the front may be used as target products.

At this point, the calculation of the above relevance may be considered to be based on a combination degree of a complete set result. Complete sets of products may be preset, and a combination degree between complete sets of products of the same brand is greater than a combination degree of complete sets of products of different brands. A combination degree of a complete set of products is greater than a combination degree of products that do not make up a complete set.

Exemplarily, since the partial products are the target products directly matched with the search request, products, a combination degree of which with the selected partial products is greater than or equal to a first preset combination degree, may be selected as the remaining products among the target products from the plurality of first products listed in the livestreaming room in the current livestreaming; and products, a combination degree of which with the selected partial products is greater than or equal to a second preset combination degree, may be selected as the remaining products among the target products from the second products listed in the livestreaming room in the various livestreaming. Or, combination degrees between the plurality of first products or the plurality of second products and the partial products are determined, and products (namely, the first products or the second products) corresponding to a preset number of combination degrees ranked in the front are used as the remaining products among the target products according to the order of the combination degrees.

The first preset combination degree and the second preset combination degree may be determined based on an actual scenario and experience. This embodiment of the present disclosure does not specifically limit this.

S103: Livestreaming preview information corresponding to the livestreaming room and product information of the target product are sent to the client to cause the client displays, on a search result page, a livestreaming card containing the livestreaming preview information and the product information of the target product.

In this step, the livestreaming preview information may include dynamic videos of the livestreaming room, promotional poster images, or the like. The product information may include information such as the name, brand, texture, model number, capacity, size, or dimension of a product.

In some embodiments, the product information of the target products that are displayed on the search result page may be determined according to the following steps: Distinguishing information of the plurality of target products for at least one attribute type is determined; and the distinguishing information under the at least one attribute type is used as the product information that is displayed on the search result page.

The attribute type may include a category, a brand, texture, a model number, and the like.

The distinguishing information of the plurality of target products for the at least one attribute type, for example, under the same lipstick brand, may include texture, color code, and the like. For another example, under the same lipstick color code, the distinguishing information may include distinguishing information such as a brand and texture.

After the livestreaming preview information corresponding to the livestreaming room and the product information of the target product are sent to the client, the livestreaming card is displayed on the search result page of the client. The livestreaming preview information may be displayed in a first region of the livestreaming card, and the product information of the target product may be displayed in a second region of the livestreaming card.

According to S101 to S103 described above, in a case that a searched livestreaming room contains a plurality of products, a target product displayed in a livestreaming card is selected from the plurality of products in the livestreaming room. Filtering and limited displaying of the products may provide a user with an effective reference suggestion, so that the user may better and more quickly obtain a desired effect.

Based on the same inventive concept, the embodiments of the present disclosure further provide a livestreaming information display method applied to a client side. A terminal device on a client side serves as an executive body, which is taken as an example to explain the livestreaming information display method provided by an embodiment of the present disclosure.

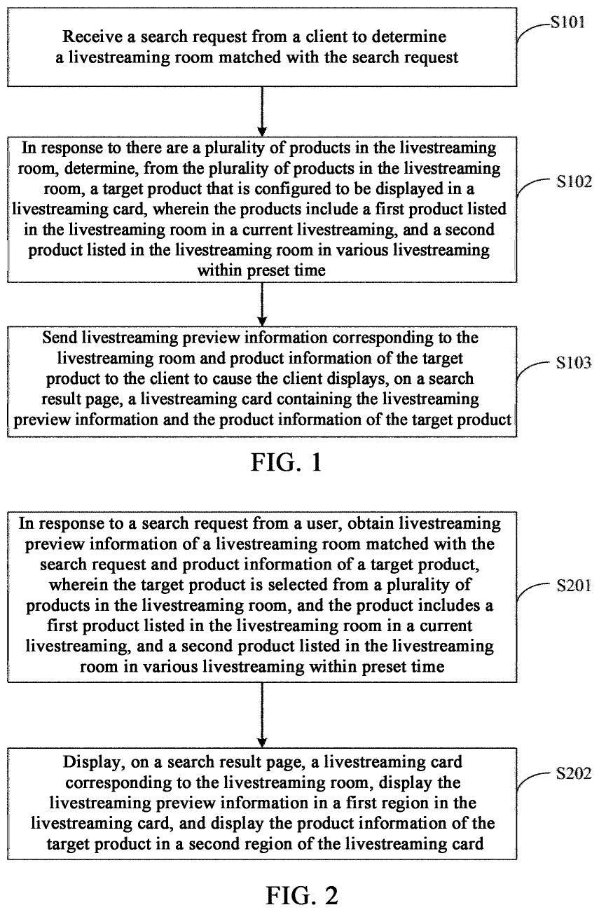

FIG. 2 is a flowchart of another livestreaming information display method provided by an embodiment of the present disclosure. The livestreaming information display method provided by an embodiment of the present disclosure is applied to a scenario for comprehensive search of information and mainly include S201 to S202 below:

S201: In response to a search request from a user, livestreaming preview information of a livestreaming room matched with the search request and product information of a target product are obtained, wherein the target product is selected from a plurality of products in the livestreaming room, and the product includes a first product listed in the livestreaming room in a current livestreaming, and a second product listed in the livestreaming room in various livestreaming within preset time.

In this step, the search request may be a request that is initiated by the user based on an own search intention on a front-end page, such as a webpage or an application (APP) page that provides various information, and attempts to obtain an information search result.

A search box may be set in the front-end page, which may initiate a comprehensive search request based on search information in the search box.

The obtained livestreaming preview information of the livestreaming room matched with the search request and the obtained product information of the target product are the livestreaming preview information of the livestreaming room matched with the search request and sent by the server to the client and the product information of the target product sent by the server to the client in the above embodiment.

A matching rule may be found in the above specific implementation process of the server side, and repetitions will not be elaborated here.

Since the target product is selected from a plurality of products in the livestreaming room, there may be one or more target products matched with the search situation.

S202: A livestreaming card corresponding to the livestreaming room is displayed on a search result page, the livestreaming preview information is displayed in a first region in the livestreaming card, and the product information of the target product is displayed in a second region of the livestreaming card.

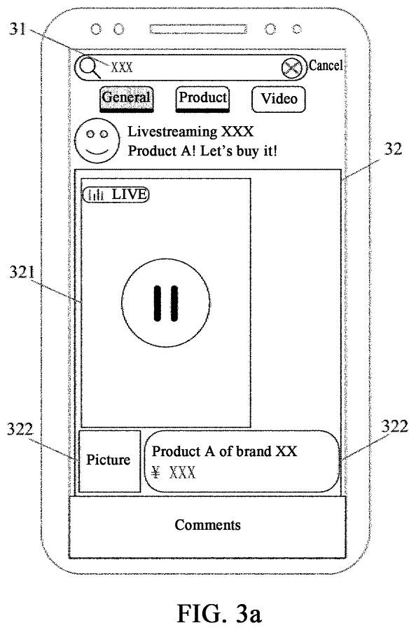

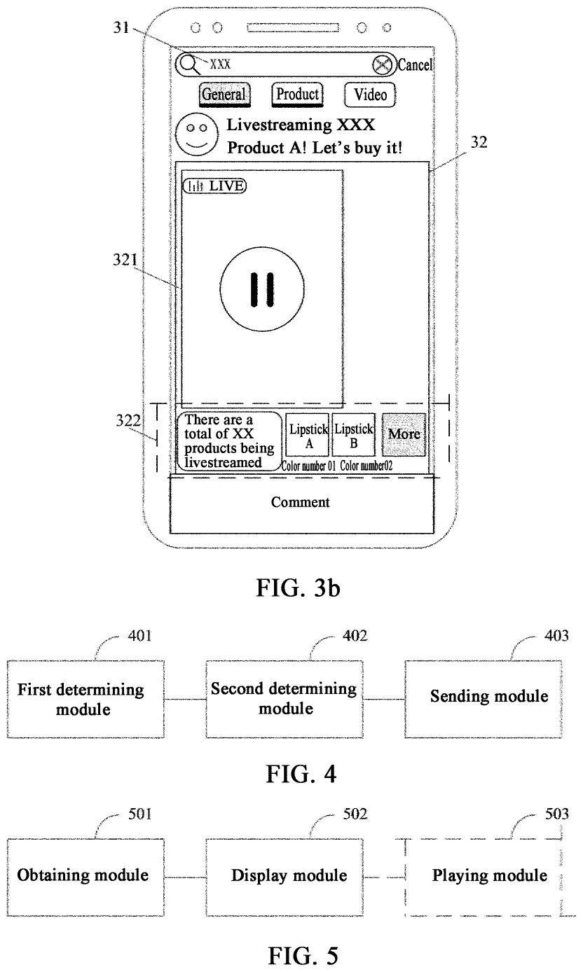

In a case that there is one target product, FIG. 3a, it shows a schematic diagram of displaying one target product on a search result page, including a search box 31 and a livestreaming card 32. Search information is displayed in the search box; the livestreaming card 32 includes a first region 321 and the second region 322. The first region 321 displays the livestreaming preview information, such as livestreaming videos during product introduction and livestreaming room views; and the second region 322 displays the product information of the target products, such as product images, brand information, and purchase prices.

In a case that there a plurality of target products, the plurality of target products may be products matched with the search request. Or, partial products among the plurality of target products may be matched with the search request, and the remaining products may be products that are combined with the partial products.

To be specific, in the above implementation, the plurality of target products displayed in the livestreaming card may all be products matched with the search request. First products matched with the search request may be preferentially selected as the target products from a plurality of first products listed in the livestreaming room in the current livestreaming. The first products matched with the search request may be products, relevance of which to the search request satisfy a first preset condition. In a case that the quantity of the selected first products does not exceed an upper limit of the quantity of the target products, second products matched with the search request may be then additionally selected as the target products from a plurality of second products listed in the livestreaming room in the various livestreaming within the preset time. The second products matched with the search request may be products, relevance of which to the search request satisfy a second preset condition. In another implementation, partial products, displayed in the livestreaming card, among the plurality of products may be matched with the search request, and the remaining products may be products that may be combined with the partial products. The products that are combined with the partial products may be products that meet a combination condition with the partial products, such as products that make up shampoo sets, products that make up clothing sets, or products that make up a discount activity with the partial products. Exemplarily, if the partial products are down jackets, the products that are combined with the partial products, namely, the remaining products, may include warm underwear, windbreaker jackets, and the like. For another example, if the partial products are lipsticks, the products that are combined with the partial products, namely, the remaining products, may include eyeshadow compacts, cosmetic cases, and the like.

FIG. 3b shows a schematic diagram of displaying a plurality of target products in a search result page. The second region 322 displays the product information of the plurality of target products, and the product information of the target products may include distinguishing information of the plurality of target products for at least one attribute type.

The attribute type of a product may include a category, a brand, texture, a model number, and the like. For the plurality of target products, the distinguishing information of the plurality of target products for one or more attribute types may be highlighted, thereby facilitating a user to perform comparative selection on the plurality of target products. For example, in a case of displaying target products of different brands in the same category, the brands, textures, model numbers, and the like of the plurality of target products may be highlighted in the product information. For another example, in a case of displaying target products of the same brand in the same category, the textures and model numbers of the plurality of target products may be highlighted in the product information. Exemplarily, if the plurality of target products are lipsticks of different brands, the product information of the plurality of lipsticks may include brand information, color code information, and the like.

In some embodiments, after the livestreaming card corresponding to the livestreaming room is displayed on the search result page, if the target product is a product that is currently being livestreamed in the livestreaming room, regardless of whether the user triggers the livestreaming preview content or the product information of the target product, playing may be started from a current introduction position of the livestreaming content, which can meet both an interest demand for the livestreaming room and an interest demand for the target product. To be specific, in response to a triggering operation performed on the livestreaming preview information or the product information of the target product, livestreaming content of the livestreaming room may be played in full screen from a current introduction position where the target product is introduced. The current introduction position may refer to a playing position of the livestreaming content corresponding to current time.

Or, in another implementation, in response to a triggering operation performed on the livestreaming preview information or the product information of the target product, livestreaming content of the livestreaming room may be played in full screen from a start introduction position where the target product is introduced in the current livestreaming room, namely, a portion, having been livestreamed, of livestreaming introduction content about the target product is replayed. The start introduction position may refer to a playing position of livestreaming content corresponding to time when the target product starts to be introduced in current livestreaming content.

In some other embodiments, after the livestreaming card corresponding to the livestreaming room is displayed on the search results page, if the target product is a product that has already been livestreamed in the livestreaming room, different playing effects may be achieved after triggering the livestreaming preview information and product information in the livestreaming card.

For the livestreaming preview information, if the user triggers the livestreaming preview information, it can be considered that the user is mainly interested in the livestreaming room. At this time, in response to a triggering operation performed on the livestreaming preview information, livestreaming content of the livestreaming room may be played sin full screen from a start introduction position or a current introduction position of the livestreaming room.

Exemplarily, in a case that the livestreaming ends, in response to the triggering operation performed on the livestreaming preview information, the livestreaming content of the livestreaming room may be replayed in full screen from the start introduction position of the livestreaming room. In a case that the livestreaming does not end, in response to the triggering operation performed on the livestreaming preview information, the livestreaming content of the livestreaming room may be played in full screen from the current introduction position.

In addition, for the product information of the target product, if the user triggers the product information, it can be considered that the user is mainly interested in the target product. At this time, in response to the triggering operation performed on the product information of the target product, the livestreaming content of the livestreaming room may be played in full screen from a historical introduction position where the target product is introduced, namely, historical livestreaming introduction content of the target product is replayed.

According to S201 to S202 described above, in a case that a searched livestreaming room contains a plurality of products, a target product displayed in a livestreaming card is selected from the plurality of products in the livestreaming room. The target product probably meets a relevant demand of the search of the user. Filtering and limited displaying of the products can provide the user with an effective reference suggestion through, for example, the livestreaming preview information corresponding to the target product and the product information of the target product, so that the user can better and more quickly obtain a desired effect, and the target achievement ratio of the user can be improved.

A person skilled in the art can understand that in the methods mentioned above of the specific implementations, the writing order of the respective step does not imply a strict execution order and imposes any restrictions on the implementation process. The specific execution order of the respective steps should be determined on the basis of functions and possible internal logics of the steps.

Based on the same inventive concept, the embodiments of the present disclosure further provide a livestreaming information display apparatus corresponding to the above livestreaming information display method applied to the server side. Since the principle of the livestreaming information display apparatus for solving the problem is similar to the above livestreaming information display method, the implementation of the apparatus may be found in the implementation of the method, and repetitions will not be elaborated here.

FIG. 4 shows a schematic diagram of a livestreaming information display apparatus provided by an embodiment of the present disclosure. The apparatus includes a first determining module 401, a second determining module 402, and a sending module 403.
a first determining module 401 is configured to receive a search request from a client, and determine a livestreaming room matched with the search request;
a second determining module 402 is configured to in a case that there is a plurality of products in the livestreaming room, determine, from the plurality of products in the livestreaming room, a target product that is configured to be displayed in a livestreaming card, wherein the products include a first product listed in the livestreaming room in a current livestreaming, and a second product listed in the livestreaming room in various livestreaming within preset time; and
a sending module 403 is configured to send livestreaming preview information corresponding to the livestreaming room and product information of the target product to the client, so that the client displays, on a search result page, a livestreaming card containing the livestreaming preview information and the product information of the target product.

In an alternative implementation, there are a plurality of target products; the plurality of target products are products matched with the search request; or, partial products among the plurality of target products are matched with the search request, and the remaining products are products that are combined with the partial products.

In an alternative implementation, the second determining module 402 is configured to determine the product information of the target products that are displayed on the search result page according to the following steps:
determining distinguishing information of the plurality of target products for at least one attribute type; and
using the distinguishing information under the at least one attribute type as the product information that is displayed on the search result page.

In an alternative implementation, the second determining module 402 is configured to: select, from a plurality of first products listed in the livestreaming room in the current livestreaming, a product as the target product, wherein a relevance between the product and the search request satisfies a first preset condition; and
select, from a plurality of second products listed in the livestreaming room in the various livestreaming within the preset time, a product as the target product, wherein a relevance between the product and the search request satisfies a second preset condition.

Based on the same inventive concept, the embodiments of the present disclosure further provide a livestreaming information display apparatus corresponding to the above livestreaming information display method applied to the client. Since the principle of the livestreaming information display apparatus for solving the problem is similar to the above livestreaming information display method, the implementation of the apparatus may be found in the implementation of the method, and repetitions will not be elaborated here.

FIG. 5 shows a schematic diagram of a livestreaming information display apparatus provided by an embodiment of the present disclosure. The apparatus includes an obtaining module 501 and a display module 502.

The obtaining module 501 is configured to: in response to a search request from a user, obtain livestreaming preview information of a livestreaming room matched with the search request and product information of a target product, wherein the target product is selected from a plurality of products in the livestreaming room, and the product includes a first product listed in the livestreaming room in a current livestreaming, and a second product listed in the livestreaming room in various livestreaming within preset time; and
the display module 502 is configured to display, on a search result page, a livestreaming card corresponding to the livestreaming room, display the livestreaming preview information in a first region in the livestreaming card, and display the product information of the target product in a second region of the livestreaming card.

In an alternative implementation, there are a plurality of target products; the plurality of target products are products matched with the search request; or, partial products among the plurality of target products are matched with the search request, and the remaining products are products that are combined with the partial products.

In an alternative implementation, the product information of the target product displayed on the search result page includes distinguishing information of the plurality of target products for at least one attribute type.

In an alternative implementation, the target product is a product that is being livestreamed in the livestreaming room; and
the apparatus further includes a playing module 503, configured to after displaying, on the search result page, the livestreaming card corresponding to the livestreaming room, in response to a triggering operation performed on the livestreaming preview information or the product information of the target product, play livestreaming content of the livestreaming room in full screen from a current introduction position where the target product is introduced.

In an alternative implementation, the target product is a product that has been livestreamed in the livestreaming room; and
the apparatus further includes a playing module 503, configured to after displaying, on the search result page, the livestreaming card corresponding to the livestreaming room, in response to a triggering operation performed on the livestreaming preview information, play livestreaming content of the livestreaming room in full screen from a start introduction position or a current introduction position of the livestreaming room; or,
in response to a triggering operation performed on the product information of the target product, play livestreaming content of the livestreaming room in full screen from a historical introduction position where the target product is introduced.

The descriptions of the processing flows of the respective modules in the apparatus and the descriptions of the interaction flows between the modules can refer to the relevant explanations in the above method embodiments, and will not be detailed here.

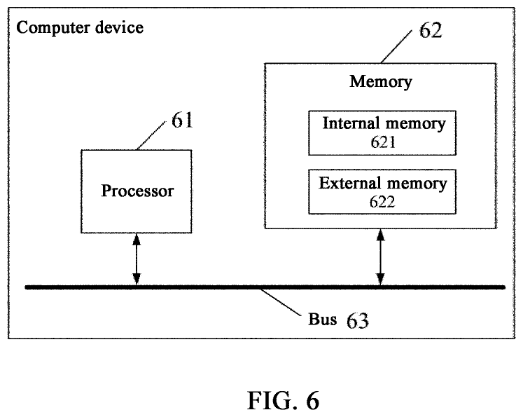

Based on the same technical concept, the embodiments of the present application further provide a computer device. FIG. 6 is a schematic structural diagram of a computer device according to an embodiment of the present application, including:
a processor 61, a memory 62, and a bus 63. The memory 62 stores machine-readable instructions executable by the processor 61; the processor 61 is configured to execute the machine-readable instructions stored in the memory 62; and when the machine-readable instructions are executed by the processor 61, the processor 61 executes the following steps: S101: a search request from a client is received, and a livestreaming room matched with the search request is determined; S102: in a case that there are a plurality of products in the livestreaming room, a target product that is configured to be displayed in a livestreaming card is determined from the plurality of products in the livestreaming room, wherein the products include a first product listed in the livestreaming room in a current livestreaming, and a second product listed in the livestreaming room in various livestreamings within preset time; and S103: livestreaming preview information corresponding to the livestreaming room and product information of the target product are sent to the client, so that the client displays, on a search result page, a livestreaming card containing the livestreaming preview information and the product information of the target product.

Or, the processor 61 executes the following steps: S201: in response to a search request from a user, livestreaming preview information of a livestreaming room matched with the search request and product information of a target product are obtained, wherein the target product is selected from a plurality of products in the livestreaming room, and the product includes a first product listed in the livestreaming room in a current livestreaming, and a second product listed in the livestreaming room in various livestreamings within preset time; and S202: a livestreaming card corresponding to the livestreaming room is displayed on a search result page, the livestreaming preview information is displayed in a first region in the livestreaming card, and the product information of the target product is displayed in a second region of the livestreaming card.

The memory 62 includes an internal memory 621 and an external memory 622. The internal memory 621 here, also referred to as an internal memory, is configured to temporarily store operational data in the processor 61 and data exchanged with the external memory 622 such as a hard disk drive. The processor 61 exchanges data with the external memory 622 through the internal memory 621. When the computer device runs, the processor 61 communicates with the memory 62 through the bus 63, causing the processor 61 to execute the executable instructions mentioned in the above method embodiments.

The embodiments of the present disclosure further provide a computer-readable storage medium, having a computer program stored thereon. The computer program, when run by a processor, execute the steps of the livestreaming information display method in the above method embodiments. The storage medium may be a volatile or a non-volatile computer-readable storage medium.

The embodiments of the present disclosure further provide a computer program product. The computer product carries program codes, and instructions included in the program codes can be used for executing the steps of the livestreaming information display method in the above livestreaming information display method embodiments. Specific details may be found in the method embodiments described above, and will not be elaborated here.

The aforementioned computer program product can be specifically implemented through hardware, software, or a combination of hardware and software. In an alternative embodiment, the computer program product is specifically embodied as a computer storage medium, while in another alternative embodiment, the computer program product is specifically embodied as a software product, such as a Software Development Kit (SDK).

A person skilled in the art can clearly understand that for the convenience and conciseness of the description, specific working processes of the system and apparatus described above can refer to the corresponding processes in the aforementioned method embodiments, and will not be described in detail here. In the several embodiments provided by the present disclosure, it should be understood that the disclosed system, apparatus, and method are achieved in other manners. The above-described apparatus embodiments are merely illustrative. For example, the division of the units is only one type of logical functional division, and other divisions is achieved in practice. For another example, multiple units or components can be combined or integrated into another system, or some features can be omitted, or not executed. In addition, the shown or discussed mutual coupling or direct coupling or communication connection is an indirect coupling or communication connection through some communication interfaces, apparatuses or units, and is in an electrical, mechanical or another form.

The units described as separate parts may or may not be physically separate, and parts displayed as units may or may not be physical units, may be located in one position, or may be distributed on a plurality of network units. Some or all of the units are selected according to actual needs to achieve the objective of the solution of this embodiment.

In addition, the functional units in various embodiments of the present disclosure may be integrated in a single processing unit. The units may exist physically separately, or two or more units may be integrated in one unit.

When the functions are implemented in the form of software functional units and sold or used as independent products, the functions may be stored in a non-volatile computer-readable storage medium executable by a processor. Based on such an understanding, the technical solutions of the present disclosure essentially, or the part contributing to the prior art, or some of the technical solutions may be presented in the form of a software product. The computer software product is stored in a storage medium, and includes several instructions for instructing a computer device (which may be a personal computer, a server, a network device, or the like) to perform all or some of the steps of the methods of the various embodiments of the present disclosure. The aforementioned storage media include: various media that can store program codes, such as a USB flash drive, a mobile hard disk drive, a Read-Only Memory (ROM), a Random Access Memory (RAM), a magnetic disk, and a compact disc.

It should be finally noted that the above embodiments are only specific embodiments of the present disclosure and are intended to explain the technical solutions of the present disclosure, rather than limiting them. The protection scope of the present disclosure is not limited to this. Although detailed explanations have been made to the present disclosure by referring to the aforementioned embodiments, a person of ordinary skill in the art should understand that any person skilled in the art can still modify the technical solutions recorded in the aforementioned embodiments or easily think of changes within the scope disclosed by the present disclosure, or equivalently replace some of the technical features. These modifications, changes, or replacements do not separate the essences of the corresponding technical solutions from the spirit and scope of the embodiments of the present disclosure, and should fall within the protection scope of the present disclosure. Therefore, the protection scope of the present disclosure shall be subject to the claims.

1. A method for displaying livestreaming information, comprising:
receiving a search request from a client to determine a livestreaming room matched with the search request;
in response to there are a plurality of products in the livestreaming room, determining, from the plurality of products in the livestreaming room, a target product that is used to be displayed in a livestreaming card, wherein the products comprise a first product listed in the livestreaming room in a current livestreaming, and a second product listed in the livestreaming room in various livestreaming within preset time; and
sending livestreaming preview information corresponding to the livestreaming room and product information of the target product to the client to cause the client display, on a search result page, a livestreaming card including the livestreaming preview information and the product information of the target product.

2. The method of claim 1, wherein there are a plurality of target products; the plurality of target products are products matched with the search request; or, partial products among the plurality of target products are matched with the search request, and the remaining products are products that are combined with the partial products.

3. The method of to claim 1, wherein a determining process of the product information of the target products that are displayed on the search result page comprises:
determining distinguishing information of the plurality of target products for at least one attribute type; and
using the distinguishing information under the at least one attribute type as the product information that is displayed on the search result page.

4. The method of claim 1, wherein determining, from the plurality of products in the livestreaming room, a target product that is used to be displayed in a livestreaming card comprises:
selecting, from a plurality of first products listed in the livestreaming room in the current livestreaming, a product as the target product, and a relevance between the product and the search request satisfies a first preset condition; and
selecting, from a plurality of second products listed in the livestreaming room in the various livestreaming within the preset time, a product as the target product, and a relevance between the product and the search request satisfies a second preset condition.

5. A method for displaying livestreaming information, comprising:
in response to a search request from a user, obtaining livestreaming preview information of a livestreaming room matched with the search request and product information of a target product, wherein the target product is selected from a plurality of products in the livestreaming room, and the product comprises a first product listed in the livestreaming room in a current livestreaming, and a second product listed in the livestreaming room in various livestreaming within preset time; and
displaying, on a search result page, a livestreaming card corresponding to the livestreaming room, displaying the livestreaming preview information in a first region in the livestreaming card, and displaying the product information of the target product in a second region of the livestreaming card.

6. The method of claim 5, wherein there are a plurality of target products; the plurality of target products are products matched with the search request; or, partial products among the plurality of target products are matched with the search request, and the remaining products are products that are combined with the partial products.

7. The method of claim 5, wherein the product information of the target product displayed on the search result page comprises: distinguishing information of the plurality of target products for at least one attribute type.

8. The method of claim 5, wherein the target product is a product that is being livestreamed in the livestreaming room;
after displaying, on the search result page, the livestreaming card corresponding to the livestreaming room, the method further comprises:
in response to a triggering operation performed on the livestreaming preview information or the product information of the target product, playing livestreaming content of the livestreaming room in full screen from a current introduction position where the target product is introduced.

9. The method of claim 5, wherein the target product is a product that has been livestreamed in the livestreaming room; and
after displaying, on the search result page, the livestreaming card corresponding to the livestreaming room, the method further comprises:
in response to a triggering operation performed on the livestreaming preview information, playing livestreaming content of the livestreaming room in full screen from a start introduction position or a current introduction position of the livestreaming room; or,
in response to a triggering operation performed on the product information of the target product, playing livestreaming content of the livestreaming room in full screen from a historical introduction position where the target product is introduced.

10. (canceled)

11. (canceled)

12. A system, comprising a server and a client wherein the server is configured to:
receive a search request from a client to determine a livestreaming room matched with the search request;
in response to there are a plurality of products in the livestreaming room, determine, from the plurality of products in the livestreaming room, a target product that is used to be displayed in a livestreaming card, wherein the products comprise a first product listed in the livestreaming room in a current livestreaming, and a second product listed in the livestreaming room in various livestreaming within preset time; and
send livestreaming preview information corresponding to the livestreaming room and product information of the target product to the client to cause the client display, on a search result page, a livestreaming card including the livestreaming preview information and the product information of the target product.

13. (canceled)

14. (canceled)

15. The system of claim 12, wherein there are a plurality of target products; the plurality of target products are products matched with the search request; or, partial products among the plurality of target products are matched with the search request, and the remaining products are products that are combined with the partial products.

16. The system of to claim 12, wherein the server is configured to determine the product information of the target products that are displayed on the search result page by:
determining distinguishing information of the plurality of target products for at least one attribute type; and
using the distinguishing information under the at least one attribute type as the product information that is displayed on the search result page.

17. The system of claim 12, wherein the server is configured to determine, from the plurality of products in the livestreaming room, a target product that is used to be displayed in a livestreaming card by:
selecting, from a plurality of first products listed in the livestreaming room in the current livestreaming, a product as the target product, and a relevance between the product and the search request satisfies a first preset condition.

18. The system of claim 17, wherein the server is further configured to determine, from the plurality of products in the livestreaming room, a target product that is used to be displayed in a livestreaming card by:
selecting, from a plurality of second products listed in the livestreaming room in the various livestreaming within the preset time, a product as the target product, and a relevance between the product and the search request satisfies a second preset condition.

19. The system of claim 12, wherein the client is configured to:
in response to a search request from a user, obtaining livestreaming preview information of a livestreaming room matched with the search request and product information of a target product, wherein the target product is selected from a plurality of products in the livestreaming room, and the product comprises a first product listed in the livestreaming room in a current livestreaming, and a second product listed in the livestreaming room in various livestreaming within preset time.

20. The system of claim 12, wherein the client is further configured to:
display, on a search result page, a livestreaming card corresponding to the livestreaming room, displaying the livestreaming preview information in a first region in the livestreaming card, and displaying the product information of the target product in a second region of the livestreaming card.

21. The system of claim 12, wherein there are a plurality of target products; the plurality of target products are products matched with the search request; or, partial products among the plurality of target products are matched with the search request, and the remaining products are products that are combined with the partial products.

22. The system of claim 12, wherein the product information of the target product displayed on the search result page comprises: distinguishing information of the plurality of target products for at least one attribute type.

23. The system of claim 12, wherein the target product is a product that is being livestreamed in the livestreaming room;
after displaying, on the search result page, the livestreaming card corresponding to the livestreaming room, the client is further configured to:
in response to a triggering operation performed on the livestreaming preview information or the product information of the target product, play livestreaming content of the livestreaming room in full screen from a current introduction position where the target product is introduced.

24. The system of claim 12, wherein the target product is a product that has been livestreamed in the livestreaming room; and
after displaying, on the search result page, the livestreaming card corresponding to the livestreaming room, the client is further configured to:
in response to a triggering operation performed on the livestreaming preview information, play livestreaming content of the livestreaming room in full screen from a start introduction position or a current introduction position of the livestreaming room; or,
in response to a triggering operation performed on the product information of the target product, play livestreaming content of the livestreaming room in full screen from a historical introduction position where the target product is introduced.
